(19) United States
(12) Patent Application Publication
(10) Pub. No.: US 2016/0127532 A1
(43) Pub. Date: May 5, 2016

(54) MOBILE DEVICE AND OPERATING METHOD

(71) Applicant: Chiun Mai Communication Systems, Inc., New Taipei (TW)

(72) Inventor: KE-HAN LEE, New Taipei (TW)

(21) Appl. No.: 14/879,545

(22) Filed: Oct. 9, 2015

(30) Foreign Application Priority Data
Oct. 29, 2014 (CN) 201410593982.X

(51) Int. Cl. H04M 1/725; G06F 3/01; G06F 3/0487; G06F 1/16; G06F 3/0482

(52) U.S. Cl. CPC H04M 1/72583; G06F 1/1694; G06F 3/0482; G06F 3/0487; G06F 3/017; H04M 1/72563

(57) ABSTRACT

A method for operating a mobile device having a low-power operational unit, at least one sensor for sensing movements of the mobile device and a touch screen includes recognizing the movements of the mobile device. Operating instructions is generated according to a predetermined corresponding relation between operating instructions and the movements stored in the storage device; and the operating instructions is performed on the mobile device.

### CROSS-REFERENCE TO RELATED APPLICATIONS

This application claims priority to Chinese Patent Application No. 201410593982.X filed on Oct. 29, 2014, the contents of which are incorporated by reference herein.

### FIELD

The subject matter herein generally relates to gestures operating technology, and particularly to a mobile device and the mobile device operating method with one hand.

### BACKGROUND

A mobile device can be used in many situations. Usually, two hands are used when operating the mobile device.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

Moreover, in the drawings, like reference numerals designate corresponding parts throughout the several views.

FIG. 1 is a block diagram of one embodiment of a mobile device.

FIG. 2 illustrates a diagrammatic table of one embodiment of a corresponding relation between movements and operating instructions.

FIG. 3 is a block diagram of one embodiment of function modules of a one-handed operating system.

FIG. 4 illustrates a flowchart of one embodiment of an operating method.

FIG. 5 is a diagrammatic view of one embodiment of a one-handed operating interface.

FIG. 6 is a diagrammatic view of a first embodiment of a one-handed operating interface.

FIG. 7 is a diagrammatic view of a second embodiment of a one-handed operating interface.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one”.

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means including, but not necessarily limited to; it specifically indicates open-ended inclusion or membership in a so-described combination, group, series and the like.

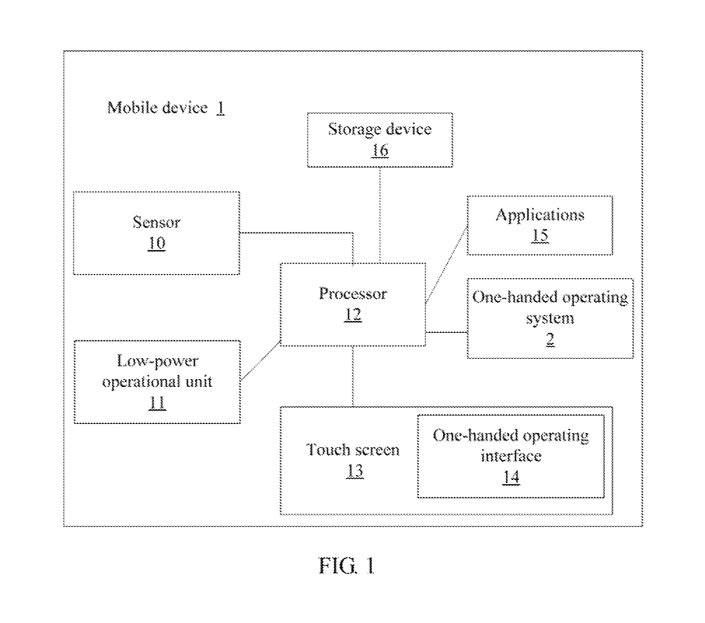

FIG. 1 illustrates a block diagram of one embodiment of a mobile device. In at least one embodiment, as shown in FIG. 1, a mobile device 1 includes, but is not limited to, at least one sensor 10, a low-power operational unit 11, at least one processor 12, a touch screen 13, a plurality of applications 15, a storage device 16, a one-handed operating system 2, and various integrated circuit, switching circuit, transistors, electron tube (not shown). In one embodiment, the mobile device 1 can be a smart phone, a tablet computer, a personal digital assistant, or any other mobile device. FIG. 1 illustrates only one example of the mobile device 1 that can include more or fewer components than illustrated, or have a different configuration of the various components in other embodiments.

In at least one embodiment, the sensor 10 can sense movements of the mobile device 1. The sensor 10 is electronically connected to the at least one processor 12, and is capable of transmitting corresponding signals to the at least one processor 12 and the low-power operational unit 11. In some embodiments, the sensor 10 can include at least one of an acceleration sensor, a gyroscope, a proximity sensor, or a position sensor.

In at least one embodiment, the low-power operational unit 11 can monitor the signals from the sensor 10 in real-time, when the at least one processor 12 and the plurality of applications 15 are in an “idle” state. The “idle” state means the low-power operational unit 11 is running while remaining components of the mobile device 1 are sleeping to conserve power.

In at least one embodiment, the at least one processor 12 can be a central operating unit (CPU), a microprocessor, or other data processor chip that performs functions of the one-handed operating system 2 in the mobile device 1.

In at least one embodiment, the touch screen 13 can provide a human-computer interaction interface, which can display different kinds of application interface (e.g., a lock screen interface, a main menu and various functions interface). The touch screen 13 can receive operational commands input by the user, for example, touch or text. In one embodiment, the touch screen 13 can display a normal operating interface. In another embodiment, the touch screen 13 can display a one-handed operating interface 14.

In at least one embodiment, the storage device 16 can include various types of non-transitory computer-readable storage medium. For example, the storage device 16 can be an internal storage system, such as a flash memory, a random access memory

(RAM) for temporary storage of information, and/or a read-only memory (ROM) for permanent storage of information. The storage device 16 can also be an external storage system, such as a hard disk, a storage card, or a data storage medium.

In some embodiments, the storage device 16 can store a predetermined corresponding relation between movements of the mobile device 1 and operating instructions. The operating instructions can include at least one of an entering instruction, an exit instruction, and an interface switching instruction and so on.

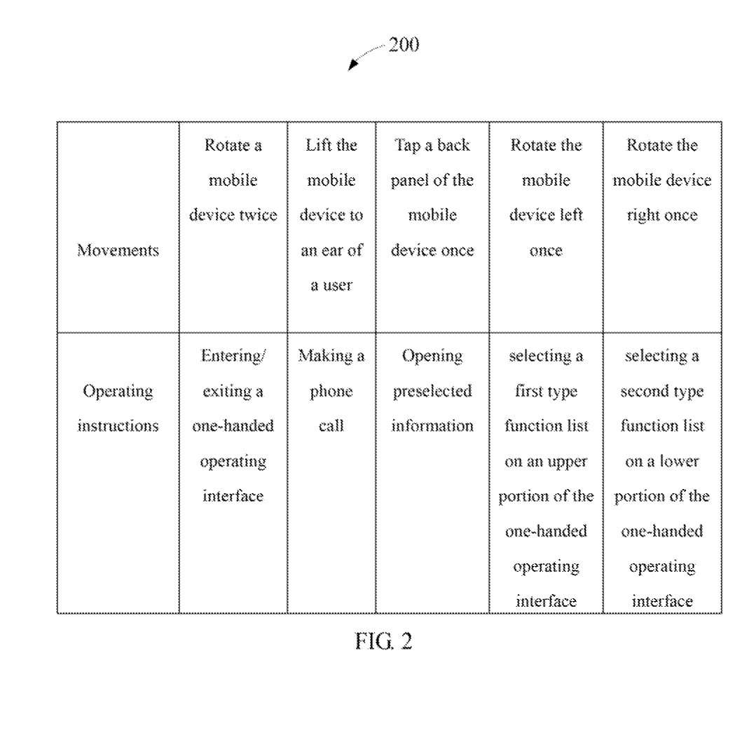

As shown in FIG. 2, an exemplary table 200 is provided by way of example, but is not limited. A movement is rotating the mobile device 1 twice within a predetermined time period (e.g., one second), a corresponding operating instruction is entering or exiting the one-handed operating interface 14. A movement is lifting the mobile device 1 to an ear of the user, a corresponding operating instruction is making a phone call to a preselected contact. Tapping a back panel of the mobile device 1 once, a corresponding operating instruction is opening preselected information. A movement is rotating the mobile device 1 left once, a corresponding operating instruction is selecting a first type function list on an upper portion of the one-handed operating interface 14 and displaying the first type function list on the touch screen 13. A movement is rotating the mobile device 1 right once, a corresponding operating instruction is selecting a second type function list on a lower portion of the one-handed operating interface 14 and then displaying the second type function list on the touch screen 13.

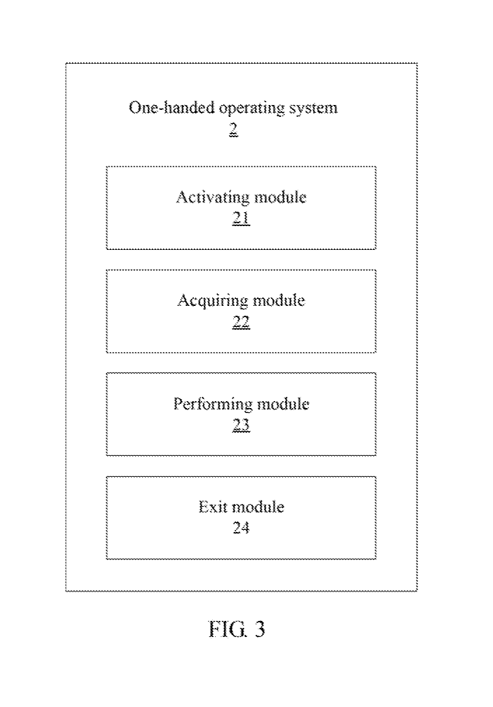

FIG. 3 is a block diagram of an exemplary embodiment of function modules of the one-handed operating system. In at least one embodiment, the one-handed operating system 2 can include an activating module 21, an acquiring module 22, a performing module 23, and an exit module 24. The function modules 21-24 can include computerized code in the form of one or more programs, which are stored in the storage device 16 of the mobile device 1. The at least one processor 12 executes the computerized code to provide functions of the modules.

The activating module 21 can activate all components of the electronic device 1, and display the one-handed operating interface 14 on the touch screen 13, when an operating instruction of entering the one-handed operating interface 14 is generated by the low-power operational unit 11.

In one embodiment, a movement in accordance with the operating instruction of entering the one-handed operating interface 14 can include tapping a back panel of the mobile device 1 twice within a predetermined time period (e.g. one second), or rotating the mobile device 1 twice within a predetermined time period (e.g. one second). In response to the operating instruction of entering the one-handed operating interface 14, the activating module 21 displays the one-handed operating interface 14 on the touch screen 13.

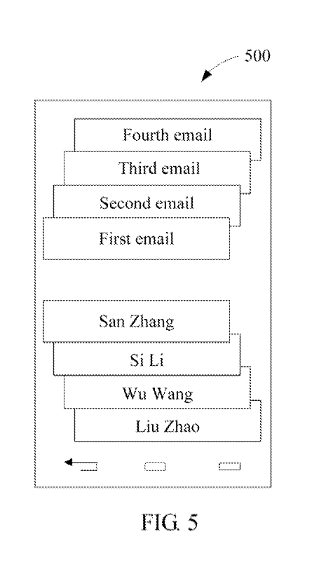

In some embodiments, the one-handed operating interface 14 can be shown as in FIG. 5. An example 500 is provided by way of example as shown in FIG. 5. The one-handed operating interface 14 on the touch screen 13 can be divided into two parts: an upper portion and a lower portion. The upper portion of the one-handed operating interface 14 can display a first type of function list, which is presented in a ladder form in a vertical direction. The lower portion of the one-handed operating interface 14 can display a second type of function list, which is presented in the ladder form in the vertical direction.

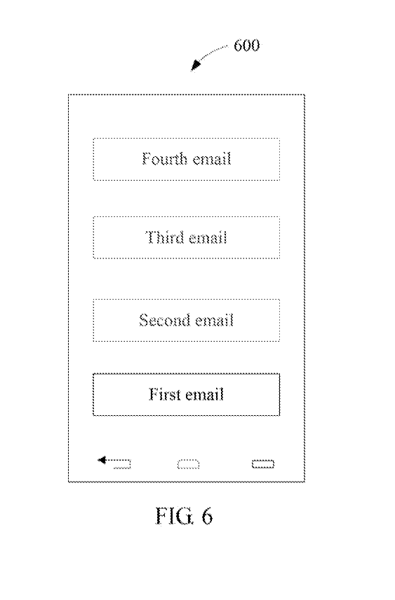

For example, as shown in FIG. 6, the upper portion of the touch screen 13 displays a list of emails, such as a first email, a second email, a third email and a fourth email, presented in the ladder form in the vertical direction. The lower portion of the touch screen 13 displays a list of call logs, such as the calls from/to San Zhang, Si Li, Wu Wang, and Liu Zhao, presented in the ladder form in the vertical direction.

The acquiring module 22 can acquire operating instructions which are generated by recognizing movements of the mobile device 1 by the low-power operational unit 11. Specifically, the acquiring module 22 acquires signals from the sensor 10. The low-power operational unit 11 recognizes the movements of the mobile device 1 according to the signals, and generates the operating instructions according to the predetermined corresponding relation between the movements of the mobile device 1 and operating instructions stored in the storage device 16.

The performing module 23 can perform the operating instructions.

In some embodiments, the touch screen 13 display the one-handed operating interface 14, the upper portion of the one-handed operating interface 14 is the list of emails, and the lower portion of the one-handed operating interface 14 is the list of call logs. When the sensor 10 senses that the mobile device 1 is rotated left once, the low-power operational unit 11 recognizes a movement of rotating left once and then generates an operating instruction of selecting the list of emails and selecting the first email. An example 600 is provided by way of example as shown in FIG. 6. The first email is at the bottom of the one-handed operating interface 14, and the fourth email is at the top of the one-handed operating interface 14. The first email is selected and in black, the second email, third email, and fourth email are in gray. When the sensor 10 senses that the mobile device 1 is rotated up once for a first time, the low-power operational unit 11 recognizes a movement of rotating up once and then generates an operating instruction of selecting the second email, then the selected second email is in black, and the other emails are in gray. When the sensor 10 senses the mobile device 1 is rotated up once for a second time, the low-power operational unit 11 recognizes a movement of rotating up once and then generates an operating instruction of selecting the third email, then the third email is in black, and the other emails are in gray. When the acquiring module 22 selects information of the list, the selected information is displayed in black and the other pieces of information are displayed in gray.

In some embodiments, the first email is selected and in black, the other emails are in gray. When the sensor 10 senses the mobile device 1 is rotated up twice within a predetermined time period (e.g. one second), the low-power operational unit 11 recognizes a movement of rotating up twice and then generates an operating instruction of selecting the third email, then the third email is in black, and the other emails are in gray.

In some embodiments, the third email is selected and in black. When the sensor 10 senses the mobile device 1 is rotated down once, the low-power operational unit 11 recognizes a movement of rotating down once and then generates an operating instruction of selecting the second email, then the second email is in black, and the other emails are in gray. When the sensor 10 senses the mobile device 1 is rotated down twice within a predetermined time period (e.g. one second), the low-power operational unit 11 recognizes a movement of rotating down twice and then generates an operating instruction of selecting the first email, the first email is in black, and the other emails are in gray. When the sensor 10 senses the back panel of the mobile device 1 is tapped once, the low-power operational unit 11 recognizes a movement of tapping once and then generates an operating instruction of opening the third email and displaying information of the third email.

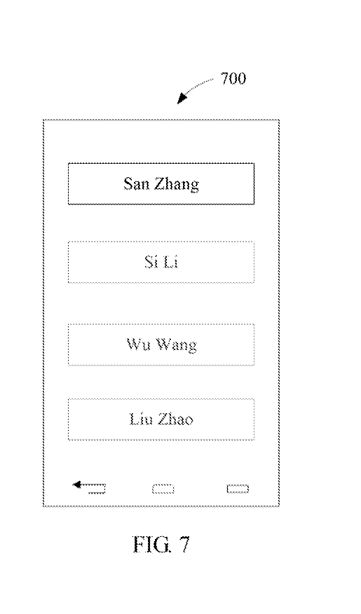

In some embodiments, the touch screen 13 displays the one-handed operating interface 14, the upper portion of the one-handed operating interface 14 is the list of emails, and the lower portion of the one-handed operating interface 14 is the list of call logs. When the sensor 10 senses the mobile device 1 is rotated right once, the low-power operational unit 11 recognizes a movement of rotating right once and then generates an operating instruction of selecting the list of call logs and selecting San Zhang. An example 700 is provided by way of example as shown in FIG. 7. Information of San Zhang is at the top of the one-handed operating interface 14, and information of Liu Zhao is at the bottom of the one-handed operating interface 14. The information of San Zhang is selected and in black, the information of Si Li, Wu Wang, Liu Zhao are in gray. When the sensor 10 senses the mobile device 1 is rotated down once for a first time, the low-power operational unit 11 recognizes a movement of rotating down once and then generates an operating instruction of selecting the information of Si Li, then the call log of Si Li is in black, and the other pieces of information are in gray. When the sensor 10 senses the mobile device 1 is rotated down once for a second time, the low-power operational unit 11 recognizes a movement of rotating down once and then generates an operating instruction of selecting the information of Wu Wang, then the information of Wu Wang is in black, and the other pieces of information are in gray.

In some embodiments, the information of San Zhang is selected and in black, the other pieces of information are in gray. When the sensor 10 senses the mobile device 1 is rotated down twice within a predetermined time period (e.g. one second), the low-power operational unit 11 recognizes a movement of rotating down twice and then generates an operating instruction of selecting the information of Wu Wang, then the information of Wu Wang is in black, and the other pieces of information are in gray.

In some embodiments, the information of Wu Wang is selected and in black. When the sensor 10 senses the mobile device 1 is rotated up once, the low-power operational unit 11 recognizes a movement of rotating up once and then generates an operating instruction of selecting the information of Si Li, then the information of Si Li is in black, and the other pieces of information are in gray. When the sensor 10 senses the mobile device 1 is rotated up twice within the a predetermined time period (e.g. one second), the low-power operational unit 11 recognizes a movement of rotating up twice and then generates an operating instruction of selecting the information of San Zhang, then the selected information of San Zhang is in black, and the other pieces of information are in gray. When the sensor 10 senses the mobile device 1 is lifted to the ear of the user, the low-power operational unit 11 recognizes a movement of lifting to the ear and then generates an operating instruction of making a phone call to Wu Wang.

It should be emphasized that no matter which state the one-handed operating interface 14 is in (for example, browsing emails, browsing pictures, or taking images through a camera, etc.), when the mobile device 1 is called by another communication device and the low-power operational unit 11 recognizes a movement of lifting the mobile device 1 to the ear, the low-power operational unit 11 generates an operating instruction of answering the call automatically. When the mobile device is in a telephone conversation and the sensor 10 senses the mobile device 1 is took away from the ear, the low-power operational unit 11 recognizes a movement of moving away from the ear and then generates an operating instruction of activating a hand-free mode. When the sensor 10 senses the mobile device 1 is lifted to the ear, the low-power operational unit 11 recognizes a movement of lifting the mobile device 1 to the ear and then generates an operating instruction of activating a receiver mode.

The exit module 24 can exit the one-handed operating interface 14 and make the mobile device 1 enter into the “idle” state, when an operating instruction of exiting the one-handed operating interface 14 is generated by the low-power operational unit 11.

In some embodiments, a movement in accordance with the operating instruction of exiting the one-handed operating interface 14 is a tap on a back panel of the mobile device 1 twice within a predetermined time period (e.g. one second), or is rotating the mobile device 1 twice within a predetermined time period (e.g. one second). In some embodiments, the movement in accordance with the operating instruction of exiting the one-handed operating interface 14 and the movement in accordance with the operating instruction of entering the one-handed operating interface 14 can be the same.

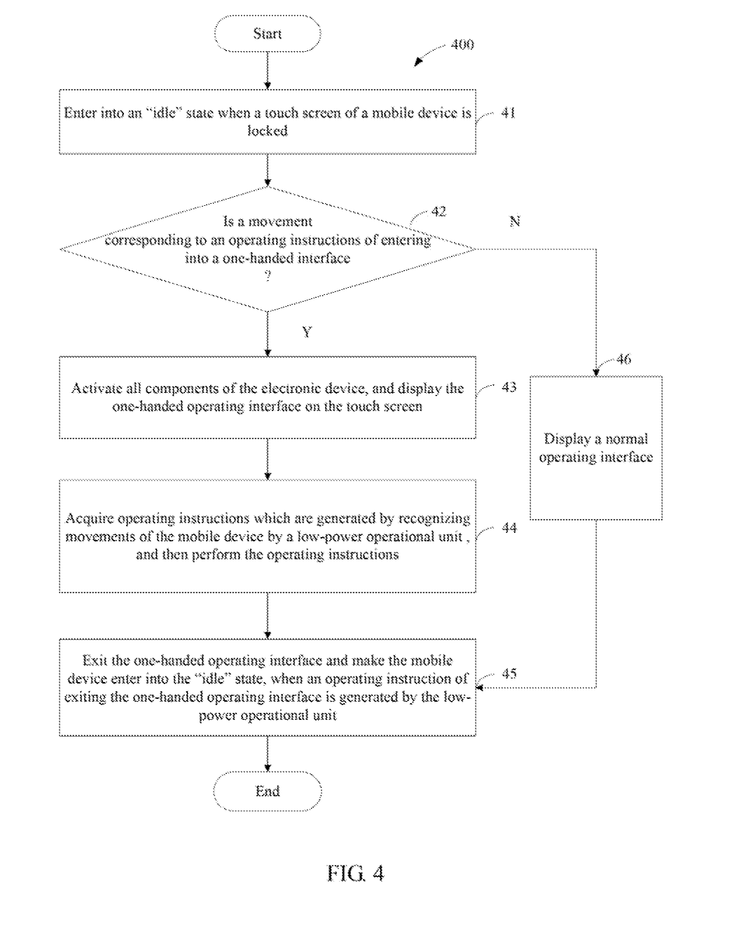

Referring to FIG. 4, a flowchart is presented in accordance with an exemplary embodiment. The exemplary method 400 is provided by way of example, as there are a variety of ways to carry out the method. The exemplary method 400 described below can be carried out using the configurations illustrated in FIG. 1 and FIG. 3, for example, and various elements of these figures are referenced in explaining exemplary method 400. Each block shown in FIG. 4 represents one or more processes, methods, or subroutines, carried out in the exemplary method 400. Furthermore, the illustrated order of blocks is by example only and the order of the blocks can be changed. The exemplary method 400 can begin at block 41. Depending on the embodiment, additional blocks can be added, others removed, and the ordering of the blocks can be changed.

At block 41, the mobile device 1 enters into the “idle” state when the touch screen 13 of the mobile device 1 is locked. In some embodiments, the “idle” state means the low-power operational unit 11 is monitoring the signals from the sensor 10 in real-time, while remaining components of the mobile device 1 are sleeping to conserve power. For example, the at least one processor 12 and various applications 15 are in a dormant state.

At block 42, the sensor 10 senses movements of the mobile device 1, and transmits the corresponding signals to the low-power operational unit 11. The low-power operational unit 11 recognizes the movements of the mobile device 1, then the low-power operational unit 11 determines whether a movement is corresponding to an operating instruction of entering the one-handed operating interface 14. If a determination is made that the movement is corresponding to the operating instruction of entering the one-handed operating interface 14, the process goes to block 43. If a determination is made that the movement is not corresponding to the operating instruction of entering the one-handed operating interface 14, the process goes to block 46.

At block 43, an activating module activates all components of the electronic device 1, and displays the one-handed operating interface 14 on the touch screen 13.

At block 44, an acquiring module acquires operating instructions which are generated by recognizing movements of the mobile device 1 by the low-power operational unit 11, and a performing module performs the operating instructions.

At block 45, an exit module exits the one-handed operating interface 14 and makes the mobile device 1 enter into the “idle” state when an operating instruction of exiting the one-handed operating interface 14 is generated by the low-power operational unit 11.

At block 46, an activating module activates all components of the electronic device 1, and displays a normal operating interface on the touch screen 13.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An operating method executable by a mobile device comprising at least one sensor for sensing movements of the mobile device, the method comprising:
recognizing the movements of the mobile device;
generating operating instructions according to a predetermined corresponding relation between the operating instructions and the movements stored in a storage device of the mobile device; and
performing the operating instructions.

2. The method according to claim 1, wherein the operating instructions comprise at least one of:
entering a one-handed operating interface;
making a phone call;
activating a hand-free mode;
selecting a first type function list on an upper portion of the one-handed operating interface;
selecting a second type function list on a lower portion of the one-handed operating interface;
opening preselected information; and
exiting the one-handed operating interface.

3. The method according to claim 2, wherein a movement corresponding to an operating instruction of entering the one-handed operating interface and a movement corresponding to an operating instruction of exiting the one-handed operating interface are the same.

4. The method according to claim 3, wherein the movement corresponding to the operating instruction of entering the one-handed operating interface and exiting the one-handed operating interface is a tap on a back panel of the mobile device twice within a predetermined time period.

5. The method according to claim 3, wherein the movement corresponding to the operating instruction of entering the one-handed operating interface and exiting the one-handed operating interface is rotating the mobile device twice within a predetermined time period.

6. The method according to claim 2, wherein the predetermined corresponding relation between the operating instructions and the movements comprises at least one of:
lifting the mobile device to an ear of a user corresponding to an operating instruction of making a phone call to a preselected contact;
taking the mobile device away from the ear corresponding to an operating instruction of activating the hand-free mode;
tapping a back panel of the mobile device once corresponding to an operating instruction of opening preselected information;
rotating the mobile device left once corresponding to an operating instruction of selecting the first type function list on the upper portion of the one-handed operating interface; and
rotating the mobile device right once corresponding to an operating instruction of selecting the second type function list on the lower portion of the one-handed operating interface.

7. A mobile device comprising:
low-power operational unit;
a touch screen;
at least one sensor for sensing movements of the mobile device;
at least one processor; and
a storage device that stores one or more programs, which when executed by the at least one processor cause the at least one processor to:
recognize the movements of the mobile device;
generate operating instructions by the low-power operational unit according to a predetermined corresponding relation between the operating instructions and the movements stored in the storage device; and
perform, by the at least one processor, the operating instructions.

8. The mobile device according to claim 7, wherein the operating instructions comprise at least one of:
entering a one-handed operating interface;
making a phone call;
activating a hand-free mode;
selecting a first type function list on an upper portion of the one-handed operating interface;
selecting a second type function list on a lower portion of the one-handed operating interface;
opening preselected information; and
exiting the one-handed operating interface.

9. The mobile device according to claim 8, wherein a movement corresponding to an operating instruction of entering the one-handed operating interface and a movement corresponding to an operating instruction of exiting the one-handed operating interface are the same.

10. The mobile device according to claim 9, wherein the movement corresponding to the operating instruction of entering the one-handed operating interface and exiting the one-handed operating interface is a tap on a back panel of the mobile device twice within a predetermined time period.

11. The mobile device according to claim 9, wherein the movement corresponding to the operating instruction of entering the one-handed operating interface and exiting the one-handed operating interface is rotating the mobile device twice within a predetermined time period.

12. The mobile device according to claim 8, wherein the predetermined corresponding relation between the operating instructions and the movements comprises at least one of:
lifting the mobile device to an ear of a user corresponding to an operating instruction of making a phone call to a preselected contact;
king the mobile device away from a ear corresponding to an operating instruction of activating the hand-free mode;
tapping a back panel of the mobile device once corresponding to an operating instruction of opening preselected information;
rotating the mobile device left once corresponding to an operating instruction of selecting the first type function list on the upper portion of the one-handed operating interface; and
rotating the mobile device right once corresponding to an operating instruction of selecting the second type function list on the lower portion of the one-handed operating interface.

13. A non-transitory storage medium having stored thereon instructions that, when executed by a processor of a mobile device, causes the processor to perform an operating method comprising:
recognizing movements of the mobile device, wherein the movements are sensed by at least one sensor of the mobile device;
generating operating instructions according to a predetermined corresponding relation between the operating instructions and the movements stored in the storage device; and
performing the operating instructions.

14. The non-transitory storage medium according to claim 13, wherein the operating instructions comprise at least one of:
entering a one-handed operating interface;
making a phone call;
activating a hand-free mode;
selecting a first type function list on an upper portion of the one-handed operating interface;
selecting a second type function list on a lower portion of the one-handed operating interface;
opening preselected information; and
exiting the one-handed operating interface.

15. The non-transitory storage medium according to claim 14, wherein a movement corresponding to an operating instruction of entering the one-handed operating interface and a movement corresponding to an operating instruction of exiting the one-handed operating interface are the same.

16. The non-transitory storage medium according to claim 15, wherein the movement corresponding to the operating instruction of entering the one-handed operating interface and exiting the one-handed operating interface is a tap on a back panel of the mobile device twice within a predetermined time period.

17. The non-transitory storage medium according to claim 15, wherein the movement corresponding to the operating instruction of entering the one-handed operating interface and exiting the one-handed operating interface is rotating the mobile device twice within a predetermined time period.

18. The non-transitory storage medium according to claim 14, wherein the predetermined corresponding relation between the operating instructions and the movements comprises at least one of:
lifting the mobile device to an ear of a user corresponding to an operating instruction of making a phone call to a preselected contact;
taking the mobile device away from the ear corresponding to an operating instruction of activating the hand-free mode;
tapping a back panel of the mobile device once corresponding to an operating instruction of opening preselected information;
rotating the mobile device left once corresponding to an operating instruction of selecting the first type function list on the upper portion of the one-handed operating interface; and
rotating the mobile device right once corresponding to an operating instruction of selecting the second type function list on the lower portion of the one-handed operating interface.
